(19) United States
(12) Patent Application Publication
(10) Pub. No.: US 2007/0109094 A1
(43) Pub. Date: May 17, 2007

(54) Method and system for dealership keyless entry

(76) Inventor: Anil K. Sahai, Webster City, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/274,778

(22) Filed: Nov. 15, 2005

(51) Int. Cl. B60R 25/00

(52) U.S. Cl. 340/5.72; 340/5.64

(57) ABSTRACT

A method and system for remote keyless entry allows for controlling different operations associated with different vehicles from a single handheld device. The system can include a database including a plurality of records, each record comprising an remote keyless entry data pattern and a vehicle identifier, a handheld device having a memory, the database stored on the memory, a remote keyless entry signal generator operatively connected to the handheld device, and an article of software executing on the handheld device and adapted for receiving the vehicle identifier and a vehicle operation and communicating an RKE data pattern associated with the vehicle identifier and vehicle operation to the remote keyless entry signal generator.

### BACKGROUND OF THE INVENTION

The present invention relates to remote keyless entry (RKE). Remote keyless entry is the well-known system typically associated with a key fob that allows one to lock and unlock a vehicle's doors, sound an alarm, open the trunk of the vehicle, turn on interior or exterior lights, or remotely perform other functions associated with a vehicle. Examples of other remote functions include remote start, or vehicle location identifying functions. Remote keyless entry comes standard or at least as an option on most vehicles made today.

Remote keyless entry systems consist of a transmitter associated with the key fob and a receiver inside of the vehicle. The transmitter located inside the key fob has a controller chip. The controller chip has a memory location that stores a code. When you push a button on your key fob, it sends that code along with a function code that tells the car what function to perform, such as locking the doors, unlocking the doors, or opening the trunk. The receiver inside the vehicle also has a controller chip. The controller chip has a memory location that holds the current code. If the receiver gets the code it expects, then it performs the requested function. If not, it does nothing. Typically, both the transmitter and the receiver use the same pseudo-random number generator. Therefore, when the transmitter sends a code, it uses the pseudo-random number generator to pick a new code, which it stores in memory. On the other end, when the receiver receives a valid code, it uses the same pseudo-random number generator to pick a new one. In this way, the transmitter and the receiver are synchronized. The receiver only opens the door if it receives the code it expects.

For security reasons, the controller chip in most modern controllers uses a hopping code or a rolling code. For example, typical RKE systems use a 40-bit rolling code. Forty bits provide 2⁴⁰ codes, this equates to roughly 1 trillion possible codes. Thus, using a rolling code nearly eliminates the potential of code capturing by would be thieves or others. If this were not the case, considering the wide proliferation of radio scanners, others could simply “capture” the code that your transmitter sends. Once someone else has “captured” your code, they can simply re-transmit it to perform a vehicle function, such as unlocking your car. With a rolling code, capturing the transmission is no longer a threat for security purposes. Typically, there is no way to predict which random number the transmitter and receiver have chosen to use as the next code, so re-transmitting the captured code has no effect, as the receiver receives an invalid code.

Typically RKE fobs are reprogrammable. For example, if the transmitter associated with the key fob and the receiver becomes desynchronized, meaning that the receiver no longer recognizes the transmitter, most vehicles provide a way to resynchronize the two. Sometimes this requires turning the ignition key on and off several times in less than so many seconds. By cycling the ignition switch this tells the security system in the car to switch over to programming mode. Then, the transmitter and receiver are resynchronized by pressing a button on any of the assigned transmitters you want the car to recognize. Other methods of reprogramming RKE fobs include pressing and holding a functional button, such as the unlock button, for a specific period of time. Typically, while holding down the functional button, and before the specific time period passes, another button on the key fob is pressed and released. For example, a user may press and hold the unlock button while pressing and releasing the panic button on the key fob. This operation switches the RKE module into programming mode so that it is set to receive a new vehicle access code. At this point the user is now free to press any button on each new key fob transmitter before the RKE module automatically times out of the programming mode. Thus, the transmitter associated with each new key fob is synchronized with the receiver in the car.

Car dealer's maintain an inventory of vehicles spread across their lots. The vehicles represent a wide number of vehicle manufacturers, makes and models. To perform the daily routine of unlocking and locking their inventory of cars dealers have developed varying tactics and approaches. Commonly, each vehicle on the lot is unlocked at the opening of each business day and subsequently locked at the close of that same business day. Some dealers opt to keep each vehicle on the lot locked until access to the interior of the car is needed or requested, whether for driving, viewing, maintenance or otherwise. In both cases, the task of locking and unlocking each vehicle on a dealer's lot represents a significant investment of the dealer's time and resources. Moreover, a prospective buyer may have lost interest or become annoyed at the time spent waiting for the sales person to retrieve the keys from the sales office. In the case where the dealer unlocks their inventory of cars at the opening of each business day, they typically use a large metal ring to hold all the keys for each vehicle on their lot. This means that an employee or employees of the car dealership walk around to each car on the lot, find the matching key on the key ring and push the unlock button on the key fob. This same process is repeated to lock the vehicles.

In the case where a dealer keeps the vehicles locked at all times, the dealer often keeps the keys inside their sale's office. Thus, sales personnel, maintenance personnel, or other dealership employees must retrieve keys from the sale's office each time access to the vehicle is needed or wanted. This same process is repeated each day and collectively represents a significant allocation of the dealership's time and resources.

Some dealerships have used window key locks to decrease the time and resources required to unlock and lock each vehicle. Thus, a dealership employee would carry a master key that opens the key lock, giving him/her access to the vehicle's keys located within the window mounted key lock.

Other dealerships are left with the time consuming task of sending someone out to roam the lots to unlock and lock each vehicle using either the key or the key fob. To increase their sales and allure to potential customers dealerships have increased their inventory size by selling vehicles from multiple manufacturers, as opposed to selling vehicles from a single manufacturer. Thus, dealership inventories have increased in number and the lot sizes have grown accordingly. This growth trend presents an increasing concern to dealerships on how to locate and manage their inventories. For example, sales personnel are forced to spend a lot of time walking back and forth between the sales office and the particular location for each vehicle. This could lead to buyers becoming frustrated having to wait each time for the sales person to run back and forth to retrieve keys. Furthermore, dealerships have had to hire additional personnel to account for the increase in lot sizes and the increased number of vehicles needing unlocked and locked each morning and night. Therefore, there is a need for a method and system that allows dealerships to fully appreciate and realize the benefits of remote keyless entry.

### BRIEF SUMMARY OF THE INVENTION

Therefore, it is a primary object, feature, or advantage of the present invention to provide a method and system for a dealer to use a handheld device to remotely access the remote keyless entry (RKE) system of a vehicle to perform vehicle functions, such as unlocking and locking the doors, location identification, opening the trunk, rolling the windows up and down, starting and stopping the engine, retracting and closing a moon roof, engaging and disengaging the alarm, turning exterior and interior lights off and on and any other vehicle functions.

A further object, feature, or advantage of the present invention is to provide a method and system for vehicle dealers using a handheld device having an expansion card for generating signals for remote keyless entry.

A still further object, feature, or advantage of the present invention is to provide a method and system for vehicle dealers using a handheld device having an expansion card having a controller for processing the remote keyless entry data pattern.

Another object, feature, or advantage of the present invention is to provide a method and system for vehicle dealers using a handheld device having an expansion card with an radio frequency (RF) antenna for sending the remote keyless entry data pattern.

A further object, feature, or advantage of the present invention is to provide a method and system for vehicle dealers using a handheld device having an expansion card with a programmable carrier frequency generator.

A still further object, feature, or advantage of the present invention is to provide a method and system for vehicle dealers using a handheld device having an expansion card with a on-off key module.

Another object, feature, or advantage of the present invention is to provide a method and system for vehicle dealers using a handheld device wherein the remote keyless entry signal generator sends a signal via the RF antenna to perform a vehicle function associated with the vehicle.

A further object, feature, or advantage of the present invention is to provide a method and system for vehicle dealers using a handheld device wherein the device executes an article of software allowing the user to select a vehicle and a vehicle operation.

A still further object, feature, or advantage of the present invention is to provide a method and system for vehicle dealers using a handheld device wherein the device software allows the user to select the vehicle according to the vehicle's identification number (VIN), model number, make type, manufacturer and/or dealership inventory vehicle control number.

Another object, feature, or advantage of the present invention is to provide a method and system for vehicle dealers using a handheld device wherein the device software allows the user to select according to each vehicle the vehicle functions to be controlled.

A further object, feature, or advantage of the present invention is to provide a method and system for vehicle dealers using a handheld device wherein the vehicle functions are any vehicle functions controllable by remote keyless entry.

A still further object, feature, or advantage of the present invention is to provide a method and system for vehicle dealers using a handheld device wherein the device software allows the user to select a vehicle or a group of vehicles for controlling vehicle functions by remote keyless entry.

Another object, feature, or advantage of the present invention is to provide a method and system for vehicle dealers using a handheld device wherein the device software allows the user to select a vehicle function or a group of vehicle functions for a group of vehicles for controlling vehicle functions by remote keyless entry.

A further object, feature, or advantage of the present invention is to provide a method and system for vehicle dealers using a handheld device having a memory for storing a database.

A still further object, feature, or advantage of the present invention is to provide a method and system for vehicle dealers using a handheld device wherein the memory stores a database of remote keyless entry codes for each of a dealership's vehicles.

Another object, feature, or advantage of the present invention is to provide a method and system for vehicle dealers using a handheld device wherein the database of remote keyless entry codes are downloaded from a dealership's server and/or inventory database.

A further object, feature, or advantage of the present invention is to provide a method and system for vehicle dealers using a handheld device wherein the database is downloadable from the dealership's server by a USB connection or an infrared serial port.

A still further object, feature, or advantage of the present invention is to provide a method and system for vehicle dealers using a handheld device in conjunction with a dealership server to acquire a remote keyless entry data pattern code.

Another object, feature, or advantage of the present invention is to provide a method and system for vehicle dealers using a handheld device in conjunction with a dealership server to acquire a decoded remote keyless entry data pattern code.

A further object, feature, or advantage of the present invention is to provide a method and system for vehicle dealers using a handheld device in conjunction with a dealership server wherein the vehicle manufacturer provides the remote keyless entry code for each vehicle in the dealership's inventory.

A still further object, feature, or advantage of the present invention is to provide a method and system for vehicle dealers using a handheld device in conjunction with a dealership server wherein the vehicle dealer acquires the remote keyless entry code from the vehicle manufacturer, using the vehicle identification number.

Another object, feature, or advantage of the present invention is to provide a method and system for vehicle dealers using a handheld device in conjunction with a dealership server wherein the remote keyless entry code is acquired using an remote keyless entry code reader and/or code learner.

A further object, feature, or advantage of the present invention is to provide a method and system for vehicle dealers using a handheld device in conjunction with a dealership server wherein the remote keyless entry code is acquired using an remote keyless entry code reader and/or code learner having an RF antenna, RF-RX module and decoder.

A still further object, feature, or advantage of the present invention is to provide a method and system for vehicle dealers using a handheld device in conjunction with a dealership server and remote keyless entry system to reduce dealership costs, provide better customer service and best use dealership resources.

Another object, feature, or advantage of the present invention is to provide a method and system for vehicle dealers using a handheld device in conjunction with a dealership server and remote keyless entry system to exploit the advantages associated with remote keyless entry.

One or more of these and/or other objects, features, or advantages of the present invention will become apparent from the following specification and claims.

According to one aspect of the present invention, a system for remote keyless entry is provided. The system includes a database comprising a plurality of records, each record comprising an remote keyless entry data pattern and a vehicle identifier, a handheld device having a memory, the database stored on the memory. There is a remote keyless entry signal generator operatively connected to the handheld device. Also, an article of software is on the handheld device and is adapted for receiving the vehicle identifier and a vehicle operation and communicating an RKE data pattern associated with the vehicle identifier and vehicle operation to the remote keyless entry signal generator. The vehicle identifier can be a vehicle identification number (VIN), a model number, or other type of description of a vehicle. The vehicle operation performed can be a lock operation, an unlock operation, a start operation, a stop operation, or other operation associated with RKE. The remote keyless entry signal generator is housed on an expansion card. There may also be a server operatively connected to the handheld device and adapted to transfer the database to the handheld device. Preferably the system is used when there are a number of different vehicles on a dealer lot.

According to another aspect of the present invention, a method for providing remote keyless entry to a vehicle on a dealership lot is provided. The method includes selecting a vehicle from a user interface associated with a handheld device, selecting a remote keyless entry operation to be performed on the vehicle using the user interface associated with the handheld device, and performing the remote keyless entry operation on the vehicle by generating an RKE signal generator associated with the handheld device.

### BRIEF DESCRIPTION OF THE DRAWINGS

FIG. 1 is a block diagram illustrating one embodiment of a system of the present invention.

FIG. 2 is a representation of a screen display associated with software running on a handheld device illustrating one embodiment of a system of the present invention.

### DETAILED DESCRIPTION OF THE PREFERRED EMBODIMENT

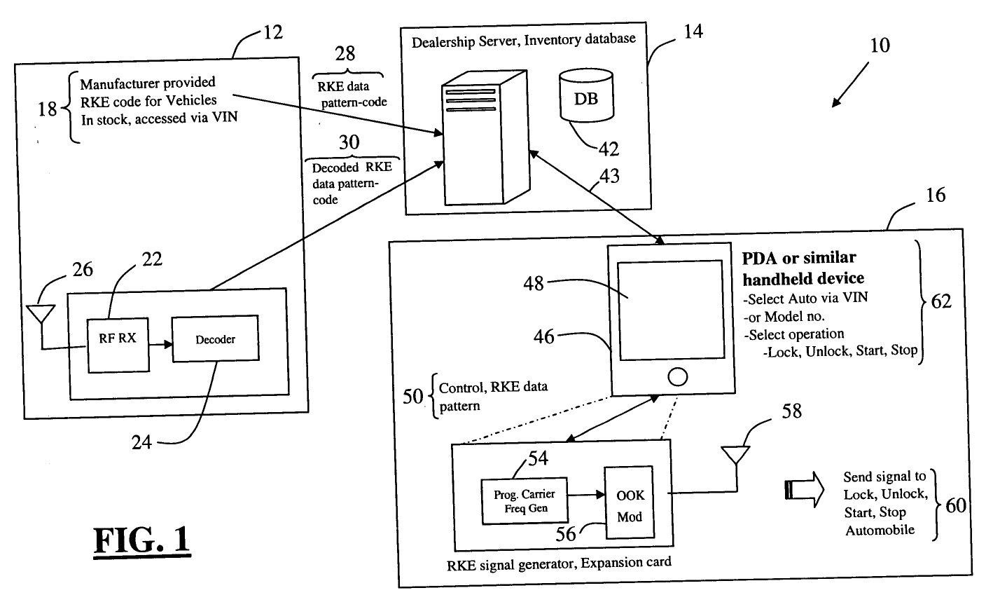

FIG. 1 illustrates one embodiment of a system of the present invention. As shown in FIG. 1, there are primary components of the system. There is a RKE code acquisition component 12, a code storage/vehicle information component 14, and a hand held device component 16.

The RKE code acquisition component 12 allows for RKE codes to be provided in one of several ways. For example, a set of codes 18 may be manufacturer provided RKE codes for vehicles in stock, accessed via VIN. Alternatively codes can be acquired for vehicle RKE systems through an RKE code reader or learner 24. The code reader 24 shown includes a housing having a radio-frequency (RF) receiver 22 operatively connected to a decoder. An RF antenna 26 is operatively connected to the RF antenna. The code reader 20 can be used with an RKE key fob to acquire a code.

The RKE data pattern-code 28 and/or the decoded RKE data pattern-code 30 are communicated to a dealership server 40 within the RKE code storage/vehicle information component 14. An inventory database 42 is accessible by the dealership server 40.

The dealership server 40 is operatively connected to a handheld device 46 through a connection, such as a USB connection 43. This connection allows the handheld device 46 to download RKE codes from the inventory database 42. The handheld device 46 can be a PDA or other type of personal electronic device. For example, the handheld device 46 can be a PALM PILOT device. The present invention is in no way limited to the particular type of handheld device used. The connection 43 need not be a USB connection, but can of any number of types of wired or wireless connections as may be appropriate in a particular application or environment.

The handheld device 46 preferably includes a display 48. Software executing on the handheld device 46 may present a screen display that gives a user various options 62. Such options may include selecting a vehicle via a VIN or model number or selecting a particular function or operation to be performed. Examples of such functions or operations include, without limitation, a lock operation, an unlock operation, a start operation, and stop operation. Of course, the present invention contemplates that numerous types of user interfaces can be used to communicate information to and from a user.

An RKE signal generator 52 is shown which is operatively connected to the handheld device 46. As shown in FIG. 1, the RKE signal generator is housed on an expansion card. The present invention contemplates, however, that the RKE signal generator may be integrated into the handheld device, or may be connected to the handheld device in different manners. The RKE signal generator includes a programmable carrier frequency generator 54 operatively connected to an on-off key module 56. A RF antenna 58 operatively connected to the on-off key module 56 is also shown. In operation, the handheld device 46 communicates control information and an RKE data pattern 50 to the RKE signal generator 52. The RKE signal generator 54 then generates the appropriate signal 60 to send a command to a vehicle. The signal 60 can include a lock command, unlock command, start command, stop command, or other command.

Thus, in operation, the handheld device can be conveniently used to initiate RKE functions associated with one or more vehicles. Such a device is particularly useful in the context of a vehicle dealership where there is a needed to perform functions such as locking and unlocking vehicles without the need to retrieve a separate key fob transmitter for each vehicle. When such a device is used and the functions include a remote start and stop, there is no need to use a key to start the vehicle. Of course, if desired, a key could be locked within each vehicle. It should further be understood that where multiple handheld devices are available, different dealership personnel can have access to the vehicles, so issues regarding key management are removed.

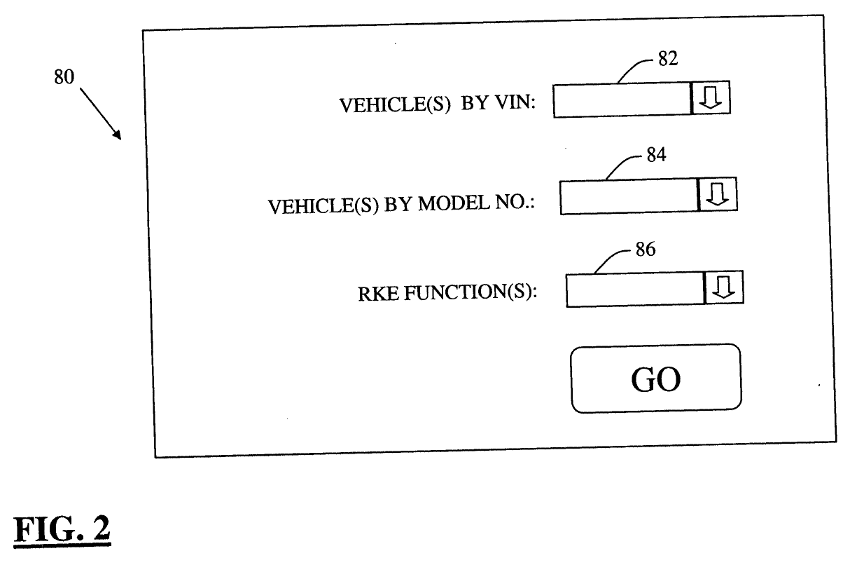

FIG. 2 illustrates one embodiment of a screen display of the present invention. The screen display 80 shown is merely exemplary. The present invention contemplates numerous variations. The screen display 80 includes a vehicle selection by VIN option 82 and a vehicle selection by model number option 84. Of course, any type of description could be used provided it is adequate to identify a particular vehicle. In addition, the vehicle by VIN option 82 or the vehicle selection by model number option 84 may allow for the selection of multiple vehicles at the same time. There is also a function selection 86 shown which allows a user to select one or more functions to be performed. Where multiple vehicles or multiple functions are selected, the present invention provides for generating the necessary RKE signals in succession until each of the selected functions for each of the selected vehicles has been performed.

It should be understood that the present invention is particularly useful when adapted to control multiple vehicles located on a dealer's lot. The system or method can assist dealership personnel in accessing vehicles to show to customers. Thus, the system and method can assist a dealership in selling vehicles by providing timely and convenient access to the vehicles.

That which has been described herein is merely exemplary and the present invention is not to be limited by this description. The present invention contemplates numerous variations in the manner of RKE code acquisition, the manner in which a handheld device communicates with an inventory database, the type of handheld device, the particular manner in which vehicles are selected, the particular manner in which vehicle functions are selected, and other variations within the spirit and scope of the claimed invention.

What is claimed is:

1. A system for remote keyless entry, comprising:
a database comprising a plurality of records, each record comprising an remote keyless entry data pattern and a vehicle identifier;
a handheld device having a memory, the database stored on the memory;
a remote keyless entry signal generator operatively connected to the handheld device;
an article of software executing on the handheld device and adapted for receiving the vehicle identifier and a vehicle operation and communicating an RKE data pattern associated with the vehicle identifier and vehicle operation to the remote keyless entry signal generator.

2. The system of claim 1 wherein the vehicle identifier is a vehicle identification number (VIN).

3. The system of claim 1 wherein the vehicle identifier is a vehicle model number.

4. The system of claim 1 wherein the vehicle operation is a lock operation.

5. The system of claim 1 wherein the vehicle operation is an unlock operation.

6. The system of claim 1 wherein the vehicle operation is a start operation.

7. The system of claim 1 wherein the vehicle operation is a stop operation.

8. The system of claim 1 further comprising a plurality of vehicles, each of the plurality of vehicles associated with the vehicle identifier of one of the records within the database.

9. The system of claim 1 wherein the remote keyless entry signal generator is housed on an expansion card.

10. The system of claim 1 further comprising a server operatively connected to the handheld device and adapted to transfer the database to the handheld device.

11. The system of claim 1 wherein the article of software is adapted to allow the user to select a plurality of vehicles to perform the vehicle operation on.

12. A method for providing remote keyless entry to a vehicle on a dealership lot, the method, comprising:
selecting a vehicle from a user interface associated with a handheld device;
selecting a remote keyless entry operation to be performed on the vehicle using the user interface associated with the handheld device;
performing the remote keyless entry operation on the vehicle by generating an RKE signal generator associated with the handheld device.

13. The method of claim 11 wherein the RKE signal generator is housed on an expansion operatively connected to the handheld device.

14. The method of claim 11 wherein the remote keyless entry operation is selected from a set consisting of a lock operation, an unlock operation, a start operation, and a stop operation.

15. The method of claim 11 further comprising selling the vehicle to a customer.

16. The method of claim 11 wherein the step of selecting a vehicle from a user interface associated with a handheld device comprises selecting a vehicle identification number (VIN) associated with the vehicle.

17. The method of claim 11 wherein the step of selecting a vehicle from a user interface associated with a handheld device comprises selecting model number associated with the vehicle.
